(19) United States
(12) Patent Application Publication
(10) Pub. No.: US 2023/0306943 A1
(43) Pub. Date: Sep. 28, 2023

(54) VOCAL TRACK REMOVAL BY CONVOLUTIONAL NEURAL NETWORK EMBEDDED VOICE FINGER PRINTING ON STANDARD ARM EMBEDDED PLATFORM

(71) Applicant: HARMAN INTERNATIONAL INDUSTRIES, INCORPORATED, Stamford, CT (US)

(72) Inventors: Jianwen ZHENG, Shenzhen, Guangdong Province (CN); Shao-Fu SHIH, San Jose, CA (US); Kai LI, Shenzhen, Guangdong Province (CN); Cheng CHI, Shenzhen, Guangdong Province (CN)

(21) Appl. No.: 18/249,913

(22) PCT Filed: Oct. 22, 2020
(86) PCT No.: PCT/CN2020/122852

§ 371 Date: Apr. 20, 2023

(51) Int. Cl. G10H 1/36; G10L 21/028; G10L 25/81; G10L 21/06; G10L 25/30

(52) U.S. Cl. CPC G10H 1/366; G10L 21/028; G10L 25/81; G10L 21/06; G10L 25/30

(57) ABSTRACT

A vocal removal method and a system thereof are provided. In the vocal removal method, a voice separation model is generated and trained to process a real-time input music to separate the voice and the accompaniment. The vocal removal method further comprises the steps of feature extraction and reconstruction to obtain the voice minimized music.

### TECHNICAL FIELD

The inventive subject matter relates generally to vocal track removal technology. More particularly, the inventive subject matter relates to a method for vocal track removal by a convolutional neural network embedded voice fingerprints.

### BACKGROUND

The first karaoke machine was invented by a Japanese musician. Soon after that, an entertaining group created the phrase on a machine, which was used instead to play the music after an orchestra went on strike. This phrase “karaoke” means “empty orchestra”.

At first the market was small but after a while, many people were getting more interest of these machines, hence the demand for them rapidly increased. In the past decades, karaoke has become a popular interactive entertainment activity, and spread to new places such as Korea, China, the U.S., and Europe with the global karaoke market estimated to be worth more than $1 billion. Many amateurs like singing along to a song following the lyrics on a screen into a microphone in a karaoke system. The real appeal of karaoke is that it is suitable for anyone, not just those who can sing well. And one can sing anywhere with a karaoke machine, such as karaoke clubs, bars and even on a street, where the audience may recognize and sing along with. It brings people together to appreciate music and creates a fun and connected atmosphere. Certainly, the song choice plays an important role in karaoke, since we need to perform something well known, which will resonate with the room. The emotional connection to these songs is what keeps people engaged, whether they're the one at the microphone or not.

Currently we can find karaoke in many public clubs and even enjoy it from the comfort of our own home with karaoke-based speaker system, such as JBL's product series “Partybox”. Usually in karaoke system, the music plays without the vocals, so that the user can sing only along with the accompaniment and will be not affected by the vocals of the original singer. However, it is difficult to find the accompaniment corresponding to one song or it may cost much to buy all we want to sing. Therefore, a voice removal algorithm is 5 required.

### SUMMARY

The inventive subject matter overcomes some of the drawbacks by providing a vocal removal method. The method comprises the following steps of training a voice separation model by a machine learning module; extracting music signal processing features of input music using a feature extraction module; processing the input music to obtain voice spectrogram mask and accompaniment spectrogram mask, separately, by the voice separation model, and reconstructing voice minimized music by a feature reconstruction module.

The inventive subject matter further provides a vocal removal system. The vocal removal system comprises a machine learning module for training a voice separation model. A feature extraction module is used to extract music signal processing features of input music. A voice separation model is used to process the input music to obtain voice spectrogram mask and accompaniment spectrogram mask, separately. And a feature reconstruction module is used to reconstruct voice minimized music.

Alternatively, the voice separation model is generated and put on an embedded platform.

Alternatively, the voice separation model comprises a convolutional neural network.

Alternatively, training the voice separation model comprises modifying the model features via machine learning.

Alternatively, extracting the music signal processing features of the input music comprises composing spectrogram images of the input music.

Alternatively, the music signal processing features comprise window shape, frequency resolution, time buffer, and overlap percentage.

Alternatively, the spectrogram images of the input music are composed using the music signal processing features.

Alternatively, processing the input music comprises input spectrogram magnitude of the input music into the voice separation model.

Alternatively, the vocal removal method further comprises modifying the music signal processing features.

Alternatively, the vocal removal method further comprises reinforce learning the voice separation model.

### BRIEF DESCRIPTION OF THE DRAWINGS

The inventive subject matter may be better understood from reading the following description of non-limiting embodiments, with reference to the attached drawings. In the figures, like reference numeral designates corresponding parts, wherein:

FIG. 1 illustrates an example flowchart of optimize the voice separation model according to one and more embodiments;

FIG. 2 is an example voice separation model generated according to one and more embodiments;

FIG. 3 shows an example flowchart to obtain the probabilities of the voice and accompaniment on the spectrogram according to one and more embodiments.

### DETAILED DESCRIPTION

The detailed description of the embodiments of the inventive subject matter is disclosed hereinafter; however, it is understood that the disclosed embodiments are merely exemplary of the inventive subject matter that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the inventive subject matter.

Due to licenses and hardware constraints, current karaoke machines are equipped with limited preprocessed music without lyrics. This has two major impact on the user experience. The first one is hardware-related, because the extra storage and the music sorting mechanism will need to be considered. Secondly, the karaoke music files are commonly remixed and commonly less harmonic complex than the original sound due to codec conversion such as MIDI. Finally, the search feature implemented in the karaoke machine also varies, sometimes frustrating for the user to find the song they would like to sing. Alternatively, there are also software applications proposed to solve this issue such as some known Chinese karaoke apps “Quan Min K Ge” and “Change Ba”. These software package keep their preprocessed music clips in the cloud and provide the solution as a streaming service. However, although the cloud service solutions could potentially solve the music remixing issue, it could suffer from search feature with additional network connection quality issue.

Because the energy of the human voice and the instrumental music have different distributions on the spectrogram, it is possible to separate the human voice from the accompaniment in music or songs. In order to accomplish this task, the machine learning and the deep neural network models are used to efficiently separate the vocal and the accompaniment in real time.

Due to the recent advance in the machine learning, vocals could be potentially separated from music by combining the voice fingerprinting identification and the binary masking, as this approach could take any offline audio file and separate the results into the voice and the background music. The proof of concept could be found in some known music multi-track separation tools, such as UnMix and Spleeter. The UnMix provides implementations for the deep learning frameworks based on deep neural networks, which provides pre-trained models to try and use the source separation. Similarly, the Spleeter is a music source separation library with pre-trained models. It makes it easy to train the source separation model when the dataset of the isolation source is ready, and provides the trained model to perform various separations. Signal to Distortion Ratio (SDR), Signal to Interference Ratio (SIR) and Signal to Artifact Ratio (SAR) were used as the separation evaluation methods in the approach and it can result in a high score on some test datasets that we will discuss below. However, since they are all offline models, user will have to upload the entire audio clip and usually takes a Windows PC or web-based application to convert a song. The process adds complexity to the user as they are required to install either PC or mobile app, which would then need another machine to playback the audio.

In order to reduce the time to play music in the Karaoke application, the inventive subject matter proposes to combine the voice processing technology which includes the reverberation and howling suppression with voice removal with the machine learning. The inventive subject matter provides a real time end-to-end model for the voice separation model, which is accomplished by the following steps: (1) Optimizing the real time inference model, (2) Feature engineering to find the best feature space for the voice identification and the real time background audio reconstruction, and (3) Reinforce learning with an additional real and synthetic dataset.

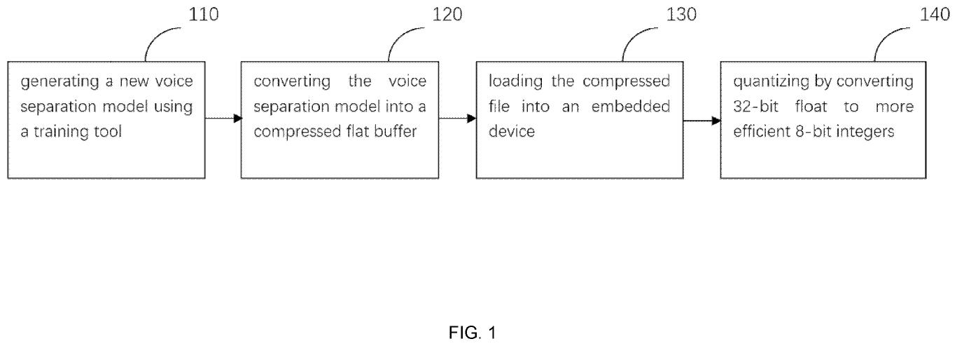

FIG. 1 illustrate an example flowchart of optimize the voice separation model according to one and more embodiments. In this example, the voice separation model is generated at Step 110 from the offline training tool, such as a known training tool named TensorFlow, or another known training tool named Pytorch. Both TensorFlow and Pytorch provide the deep machine learning frameworks. At Step 120, since running the machine learning models on the embedded real time systems are significantly more resource constrained, the generated voice separation model needs to be converted to an efficient inference model by using for example the Tensorflow Lite converter. Generally, the Tensorflow Lite converter is designed to execute models efficiently on embedded devices with limited compute and memory resources. Thus, the voice separation model is converted into a compressed flat buffer, and thus its file data is reduced.

In the next Step 130 of FIG. 1, the compressed file of the voice separation model is loaded into an embedded device, such as a known standard ARM (Advanced RISC Machines) embedded platform, for the model training and usage. Afterwards, the file size can be further reduced and quantized by converting 32-bit float to more efficient 8-bit integers at Step 140. In this way, the file of the voice separation model can be compressed to ¼ of the original size, for example.

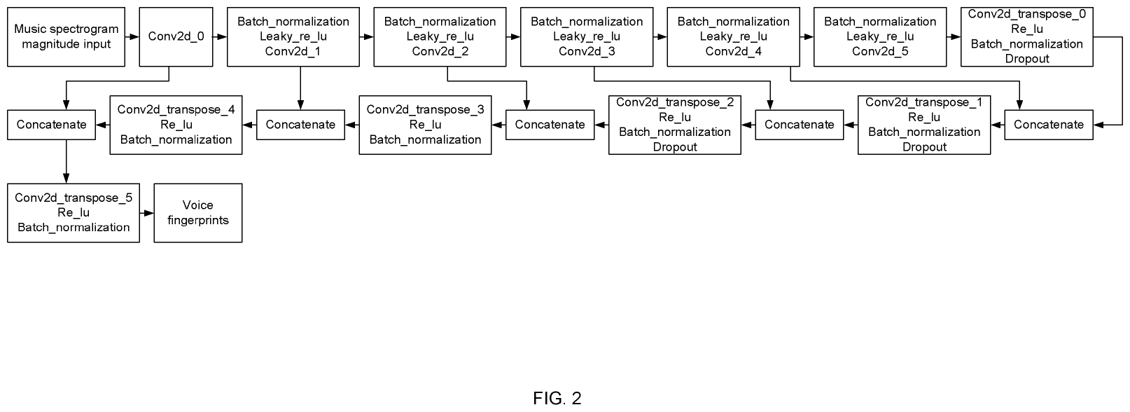

Next, in an example, the voice separation model is generated as a kind of convolutional neural network. FIG. 2 shows an example architecture of the voice separation model. In the example, the architecture of the voice separation model is a two-dimensional (2D) convolutional neural network, which can be generally described as including encoder layers and decoder layers. Each of the encoder layers comprises a 2D convolution denoted as ‘conv2d’, a batch normalization denoted as ‘batch_normalization’, and a leaky version of a rectified linear unit denoted as ‘leaky_re_lu’. As can be seen from FIG. 2, a music spectrogram magnitude is input to the 2D convolutional neural network and enters the first encoder layer. Here the music spectrogram magnitude is processed by multiple 2D convolutions. There are six 2D convolutions included in the encoder layers of this 2D convolutional neural network, respectively denoted as conv2d_0, conv2d_1, conv2d_2, conv2d_3, conv2d_4, and conv2d_5. The 2D convolution may be implemented by calling the function conv2d in the TensorFlow. It can be seen that except for the first 2D convolution (Conv2d_0), the batch_normalization (Batch_normalization) layer and the leaky version of a rectified linear unit (Leaky_re_lu) are added before each of the subsequent 2D convolutions, respectively.

The decoder layers are arranged after the last 2D convolution (Conv2d_5). Similarly, in the decoder layers there are six 2D convolution transposes denoted as Conv2d_transpose_0, Conv2d_transpose_1, Conv2d_transpose_2, Conv2d_transpose_3, Conv2d_transpose_4, and Conv2d_transpose_5, respectively. A rectified linear unit (Re_lu), and a batch normalization (Batch_normalization) are used after each of the 2D convolution transposes. Therefore, in this 2D convolutional neural network, after processed by six 2D convolution in the encoder layers and by six 2D convolution transposes in the decoder layers, the result spectrogram returns to its original size.

As shown in FIG. 2, in the decoder layers, each result of the 2D convolution transpose is further concatenated with the result of the corresponding 2D convolution in the previous encoder layer before entering the next 2D convolution transpose. As shown, the result of the first 2D convolution transpose (Conv2d_transpose_0) in the decoder is concatenated with the result of the fifth 2D convolution (Conv2d_4) in the encoder, the result of the second 2D convolution transpose (Conv2d_transpose_1) in the decoder is concatenated with the result of the forth 2D convolution (Conv2d_3) in the encoder, the result of the second 2D convolution transpose (Conv2d_transpose_2) is concatenated with the result of the forth 2D convolution (Conv2d_2), the result of the second 2D convolution transpose (Conv2d_transpose_2) is concatenated with the result of the forth 2D convolution (Conv2d_2), the result of the second 2D convolution transpose (Conv2d_transpose_3) is concatenated with the result of the forth 2D convolution (Conv2d_1), and the result of the fifth 2D convolution transpose (Conv2d_transpose_4) is cascaded with the result of the first 2D convolution (Conv2d_0). Then, after the last 2D convolution transpose(Conv2d_transpose_5), the voice separation model ends at its output layer. For the music spectrogram magnitude input, the output of the voice separation model obtains voice fingerprints. The voice fingerprints can be considered as the summarized features of the voice separation model. In the example, the voice fingerprints reflect the weight of each layer in the 2D convolutional neural network.

In the example, the batch normalization in the voice separation model performs normalizing in batch, which is to re-normalize the result of each layers and to provide a good data for passing through the next layer of the neural network. The rectified linear unit (ReLU) with its function expressed as f(x)=max (0, x) performed after the transpose of 2D convolution and the Leaky version of a rectified linear unit (Leaky_re_lu) with its function expressed as f(x)=max (kx, 0) performed after the 2D convolution are both used to prevent the vanishing gradient problems in the voice separation model. Moreover, in the example of FIG. 2, 50% dropout is used to the first three layers of the six 2D convolution transposes, which is to prevent the voice separation model from overfitting.

The voice separation model can be trained using a music with its known voice track and its known accompaniment track. The voice fingerprints of this music can be calculated form the know voice track and the know accompaniment track. Placing these voice fingerprints of this music as the trained voice fingerprints on the output layer of the voice separation model, and placing the spectrogram magnitude of this music on the input layer, respectively, the voice separation model can be trained by the machine learning constantly trying and modifying the model features. In the 2D convolutional neural network, the model features modified during the model training include such as the weight and bias of the convolution kernel, and the batch normalization matrix parameters.

The trained voice separation model has the fixed model features and parameters. By using a trained model to process a new music spectrogram magnitude input, the probability of voice and accompaniment on the spectrogram can be obtained. The trained model can be expected to achieve more real-time processing capabilities and better performance.

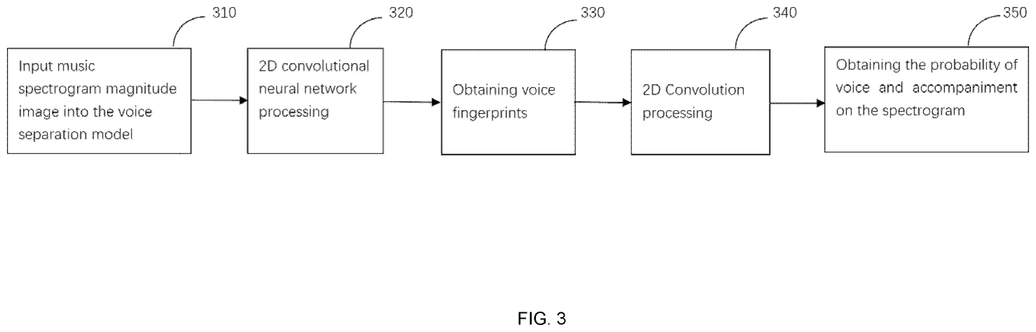

FIG. 3 shows an example flowchart to obtain the probabilities of the voice and accompaniment on the spectrogram. In the example, there is a new piece of music needs to remove the voice. The music spectrogram magnitude is input into the trained voice separation model at Step 310. After processing by the 2D convolutional neural network at Step 320, the voice fingerprints are obtained at Step 330. Again, processing the voice fingerprints with a 2D convolution at Step 340, the probability of the voice and the accompaniment for each frequency bin in each pixel of the spectrogram can be obtained at Step 350.

The spectrogram magnitude of a piece of music is a two-dimensional graph represented in a time dimension and a frequency dimension. The spectrogram magnitude thus can be divided into a plurality of pixels by such as the time unit of the abscissa and the frequency unit of the ordinate. The probability of the voice and the accompaniment in each pixel on the spectrogram can be marked. Therefore, the voice mask and the accompaniment mask are obtained by combining the pixels marking their respective probabilities, respectively. The output voice spectrogram magnitude is given by applying the voice spectrogram mask obtained by the trained voice separation model to the magnitude of the original input music spectrogram magnitude. Therefore, the voice spectrogram mask can be used for the audio reconstruction.

Since generally the training time of the models is based on the offline processing therefore the computation resources are generally not taken into consideration to provide the best performance. First problem is the unrealistic size of the music input, of which the time duration was too long and would lead to a one-minute delay. The original network was not acoustically optimized, so the following processing for feature extraction and reconstruction is additionally provided.

There are some definitions for introduce the feature extraction and reconstruction, comprising as follow:
x(t): the input signal in the time domain representation;
X(f): the input signal in the frequency domain representation after short time Fourier transform;
Xₙ(f): the spectrogram of the input signal starting with time frame n.

When a piece of music x(t) needs to be processed by the deep neural network to extract its features and reconstruct its accompaniment, firstly the input music needs to be transformed to the frequency domain representation and then composed its spectrogram images by:

x(t)=overlap(input,50%) (1)

xₕ(t)=windowing(x(t)) (2)

Xₙ(f)=FFT(xₕ(t)) (3)

X_{nb}(f)=[|X₁(f)|,|X₂(f)| . . . |Xₙ(f)|] (4)

Wherein the functions overlap(*) and windowing(*) are the overlap and windowing processing, respectively; the FFT is Fourier transform and |*| is the absolute value operator, and X_{nb}(f) is the buffer of Xₙ(f). Thus, X_{nb}(f) represents the composed spectrogram magnitude images of the piece of music x(t).

Then, the X_{nb}(f) is input to the 2D convolutional neural network and is processed to obtain the result processed spectrogram X_{nbp}(f). Thus, X_{nbp}(f) represents the voice spectrogram mask or the accompaniment spectrogram mask.

Afterwards, the processed spectrogram X_{nbp}(f) is combined with the original input spectrogram to prevent artifacts by using smoothing as follow:

Y_{nb}(f)=X_{nb}(f)*(1−α(f))+X_{nbp}(f)*α(f) (5)

wherein X_{nbp}(f) is the processed spectrogram obtained by the deep neural network processing. The coefficient α is get from α=sigmoid (voice mask)*(perceptual frequency weighting), and the sigmoid function is defined as

$$S ( x ) = \frac{1}{1 + {e}^{- x}} ,$$

wherein the parameter voice mask stands for the voice spectrogram mask, wherein the perceptual frequency weighting is determined by experimental values.

Finally, the voice magnitude mask or the accompaniment magnitude mask predicted by the trained voice separation model here can be applied to the magnitude of the original spectrogram to obtain the output voice spectrogram or the output accompaniment spectrogram. the spectrogram is transformed back to the time domain with the inverse short time Fourier transform and the overlap-add method as follow:

Y_{nbc}(f)=Y_{nb}(f)*e^{i*phase(X}^{_{nb}}^{(f))} (6)

y_{b}(t)=iFFT(Y_{nbc}(f)) (7)

yₕ(t)=windowing(y_{b}(t)) (8)

y(t)=overlap_add(yₕ(t),50%) (9)

where iFFT is inverse Fourier transform, and overlap_add(*) is the overlap add function used in the over-add method.

The above provided processing for feature extraction and reconstruction can be considered as the newly added layers into the convolutional neural network. An upgraded voice separation model can be described by comprising the convolutional neural network plus the above newly added layers. The music signal processing features, such as window shape, frequency resolution, time buffer, and overlap percentage, included in this upgraded voice separation model can be modifying via the machine learning.

After converting the upgraded voice separation model to real time executable models, we finally made were able to hear the reconstructed voice minimized music.

Finally, the last step is the reinforce learning with the additional real and synthetic dataset. With fix the upgraded voice separation model in place, since the multiple parameters of the model features have been modified, the performance of the model has greatly improved. To minimize the impact of feature space misalignments, we would need to reinforce the provided upgraded voice separation model using the new parameter space with additional data. In this case, the additional data of music with its known soundtracks are needed. In a way of example, the additional data can be from a known music database “Musdb18”, which is a dataset of 150 full lengths music tracks (˜10 h duration) of different genres along with their isolated drums, bass, vocals and others stems. It contains two folders, a folder with a training set: “train”, composed of 100 songs, and a folder with a test set: “test”, composed of 50 songs. The supervised approaches should be trained on the training set and tested on both sets. In the example, all the signals are stereophonic and encoded at 44.1 kHz. In another way of example, the users of the model can also use their own proprietary dataset which came with separated multi-tracks for both voice and background music tracks such as piano, guitar, etc. In this example, the user can run the dataset through the feature extraction and storing the modified music signal features. Then with the old pretrained model, training framework, converted feature space in hand, the user is able to use transfer learning to adapt from the old music signal features to the new one.

By using modern machine learning models with transfer learning, the user is able to deploy real time voice removal for users. The inventive subject matter eliminates the need of the search function in conventional Karaoke machines and minimize the difference between the karaoke track and the original track. By further combining the model with reverberation and howling suppression, a complete system can be created that allows any music streams to be converted to karaoke tracks and allows users to sing in low latency with arbitrary analog microphones.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

While exemplary embodiments are described above, it is not intended that these embodiments describe all possible forms of the inventive subject matter. Rather, the words used in the specification are words of description rather than limitation, and it is understood that various changes may be made without departing from the spirit and scope of the inventive subject matter. Additionally, the features of various implementing embodiments may be combined to form further embodiments of the inventive subject matter.

1. A vocal removal method, comprising the steps of:
training, by a machine learning module, a voice separation model;
extracting, by a feature extraction module, music signal processing features of input music;
processing the input music, by the voice separation model, to obtain voice spectrogram mask and accompaniment spectrogram mask, separately; and
reconstructing, by a feature reconstruction module, voice minimized music.

2. The vocal removal method of claim 1, wherein the voice separation model is generated and put on an embedded platform.

3. The vocal removal method of claim 1, wherein the voice separation model comprises a convolutional neural network.

4. The vocal removal method of claim 3, wherein training the voice separation model comprises modifying features of the voice separation model via machine learning.

5. The vocal removal method of claim 1, wherein extracting the music signal processing features of the input music comprises composing spectrogram images of the input music.

6. The vocal removal method of claim 1, wherein the music signal processing features comprises window shape, frequency resolution, time buffer, and overlap percentage.

7. The vocal removal method of claim 5, wherein the spectrogram images of the input music is composed using the music signal processing features.

8. The vocal removal method of claim 1, wherein processing the input music comprising input spectrogram magnitude of the input music into the voice separation model.

9. The vocal removal method of claim 1, further comprises modifying the music signal processing features.

10. The vocal removal method of claim 1, further comprises reinforce learning the voice separation model.

11. A vocal removal system, comprising:
a machine learning module for training a voice separation model;
a feature extraction module for extracting music signal processing features of input music, wherein the voice separation model processes the input music to obtain voice spectrogram mask and accompaniment spectrogram mask, separately; and
reconstructing, by a feature reconstruction module, voice minimized music.

12. The vocal removal system of claim 11, wherein the voice separation model is generated and put on an embedded platform.

13. The vocal removal system of claim 11, wherein the voice separation model comprises a convolutional neural network.

14. The vocal removal system of claim 13, wherein training the voice separation model comprises modifying features of the voice separation model via machine learning.

15. The vocal removal system of claim 11, wherein extracting the music signal processing features of the input music comprises composing spectrogram images of the input music.

16. The vocal removal system of claim 11, wherein the music signal processing features comprises window shape, frequency resolution, time buffer, and overlap percentage.

17. The vocal removal system of claim 15, wherein the spectrogram images of the input music is composed using the music signal processing features.

18. The vocal removal system of claim 11, wherein processing the input music comprising input spectrogram magnitude of the input music into the voice separation model.

19. The vocal removal system of claim 11, further comprises modifying the music signal processing features.

20. The vocal removal system of claim 11, further comprises reinforce learning the voice separation model.
